(19) United States
(12) Patent Application Publication
(10) Pub. No.: US 2013/0062981 A1
(43) Pub. Date: Mar. 14, 2013

(54) Vertical hydraulically suspended armature generator

(71) Applicant: Charles Harry Smith, Yucaipa, CA (US)

(72) Inventor: Charles Harry Smith, Yucaipa, CA (US)

(21) Appl. No.: 13/199,936

(22) Filed: Sep. 14, 2011

(51) Int. Cl. H02K 7/08; H02K 53/00

(52) U.S. Cl. 310/90; 74/DIG. 9

(57) ABSTRACT

A power generator (1) in a vertical design supplying electrical power comprising a base support assembly (4) for the vertical armature (2). A hydraulic system to a fluid chamber (23) within the base support assembly (4) to raise the armature (2) and then suspend the armature (2) during rotating movement. A sleeve fitting shaft support assembly (5) with a pressurized lubricating system to the sleeve fitting (29). An electrical motor (7) with a clutch (6) to provide rotational drive to the hydraulically suspended armature (2) to supply electric power to an electrical load (21) and to supply electrical power to replace the initial outside power (17) to operate the generator.

I claim for benefit the filing date provisional application 61/460,627 filed Jan. 6, 2011.

### FIELD OF THE INVENTION

The present invention relates to the field of power generation and to a generator with efficient innovative features possible with a generator operating in a vertical position.

### BACKGROUND OF THE INVENTION

The common horizontal design for the electric power generator has persisted with an emphasis on different types of energy to muscle the motion of the generator to produce electricity. The inherent inefficient design of the weight supporting surface areas for the armature shaft produce friction and heat requiring additional fuel energy to overcome that drag resulting in additional expense and pollution.

A purpose of the present invention is to eliminate the weight bearing surface areas supporting the armature shaft by utilizing an armature in a vertical design with sleeve fittings and by hydraulically suspending the weight of the armature on a liquid.

### SUMMARY OF THE INVENTION

In view of the foregoing background, it is therefore the object of the present invention to provide a power electric generator with innovative design that is substantially more fuel efficient producing less pollution and occupying a smaller area on a power plant site.

Advantages of the present invention are available when the armature is in a vertical position allowing the entire weight of the armature to one contact area at the bottom end of the armature shaft piston that can be hydraulically suspended on a fluid eliminating any weight bearing metal to metal contact of the armature shaft with any support contact areas.

The vertical design of the armature allows for fine balancing of the armature on the axis of its shaft reducing resistance to its rotating motion.

The vertical armature allows for none weight bearing sleeve stabilizing support assembly along the armature shaft with pressurized fluid lubricating the fitting of the armature shaft and the support assembly, reducing friction there.

The pressurized fluid from the base fluid chamber flowing up between the cylinder wall of the chamber and the wall of the piston end of the armature shaft reduces friction there.

Any preferred means to rotationally drive the armature connected to the armature shaft at any preferred area in any preferred manner will require less energy of any kind to operate the generator and less time and energy for start up.

A less powerful electric motor is required to rotationally drive the generator. When the generator is operational, the outside source initially powering the generator can be replaced by power from the generator and still provide substantial power for the load. Batteries when used as the initial power source can be recharged by power from the generator.

The vertical design generator requires less floor area in military, government, or commercial buildings. The generator can be installed at floor level with support wall bracing or installed in a silo structure. It can be installed at a preferred sunken level or in a silo completely underground providing maximum stability and protection from natural disaster, terrorism, or military engagement. The generator power can be used as backup or regular power. The electric power can be sold to tenants or sold to the grid.

The vertical hydraulically suspended armature generator in a variety of sizes can be permanently mounted, portable for temporary use, or can be used by craft and vehicle as a movable electrical power source.

### BRIEF DESCRIPTION OF THE DRAWINGS

FIG. 1 is a schematic view of a vertical power generator according to the present invention.

FIG. 2 is a view similar to FIG. 1, but showing sectional views of the armature shaft, the base support assembly, and the shaft support unit.

FIG. 3 is a sectional view of the armature shaft collar, the shaft piston end, and the base support assembly showing the armature when raised by pressurized fluid.

### LIST OF DRAWING REFERENCE NUMERALS

1—vertical generator

2—vertical armature shaft

3—armature shaft collar

4—base support assembly

5—armature shaft support and lubricating assembly

6—clutch

7—electric motor

8—fluid reservoir

9—fluid pump

10—one-way fluid pressure retaining valve

11—fluid return pump

12—fluid reservoir

13—fluid pump

14—one-way fluid pressure valve

15—shaft assembly pump switch

16—motor switch

17—outside power source

18—generated power source

19—generator system power source switch

20—load switch

21—load

22—fluid entrance port

23—base support assembly cylindrical fluid chamber

24—armature shaft piston end

25—fluid flow channel

26—fluid collection chamber

27—fluid exit port

28—fluid entrance port

29—sleeve fitting

30—fluid return pump

31—fluid collection chamber

32—fluid exit port

33—fluid collection chamber

34—fluid exit port

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiment set forth herein. Rather, these embodiments are provided so that this disclosure will be thorough and complete, and will fully convey the scope of the invention. Like numbers refer to like elements throughout.

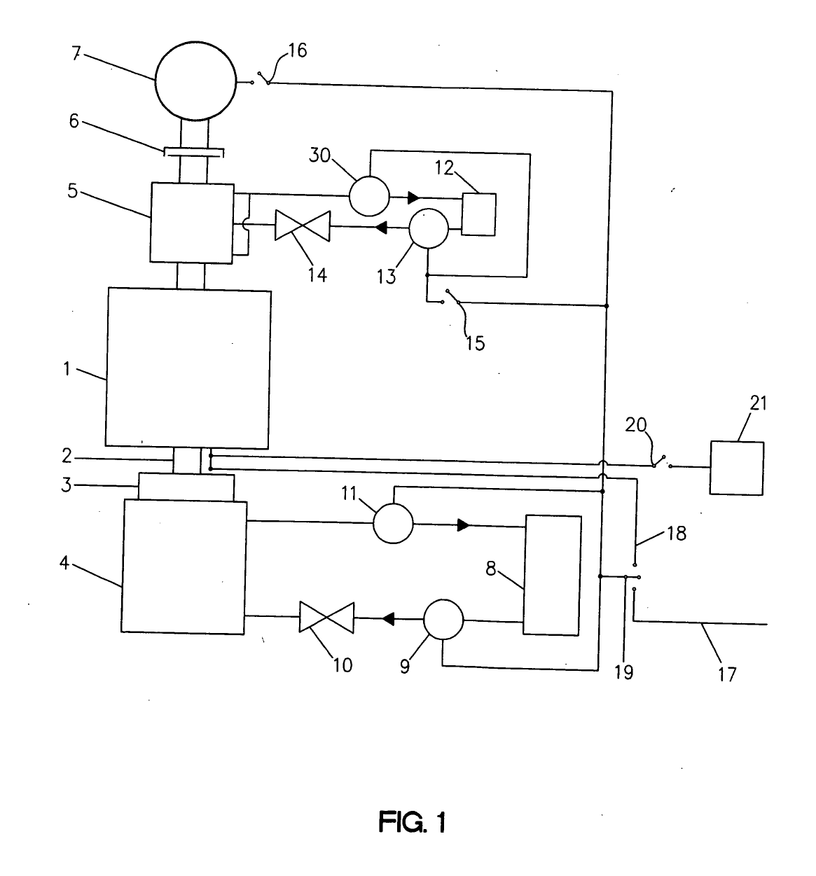

Referring initially to FIG. 1, an electric power generator in a vertical design according to the present invention shown in a schematic is now described. The vertical generator system comprise a vertical generator 1, a base support assembly 4 with a hydraulic system, a shaft support assembly 5 with a fluid lubricating system, a clutch 6 connecting the vertical armature shaft 2 to an electrical motor 7 having a power switch.

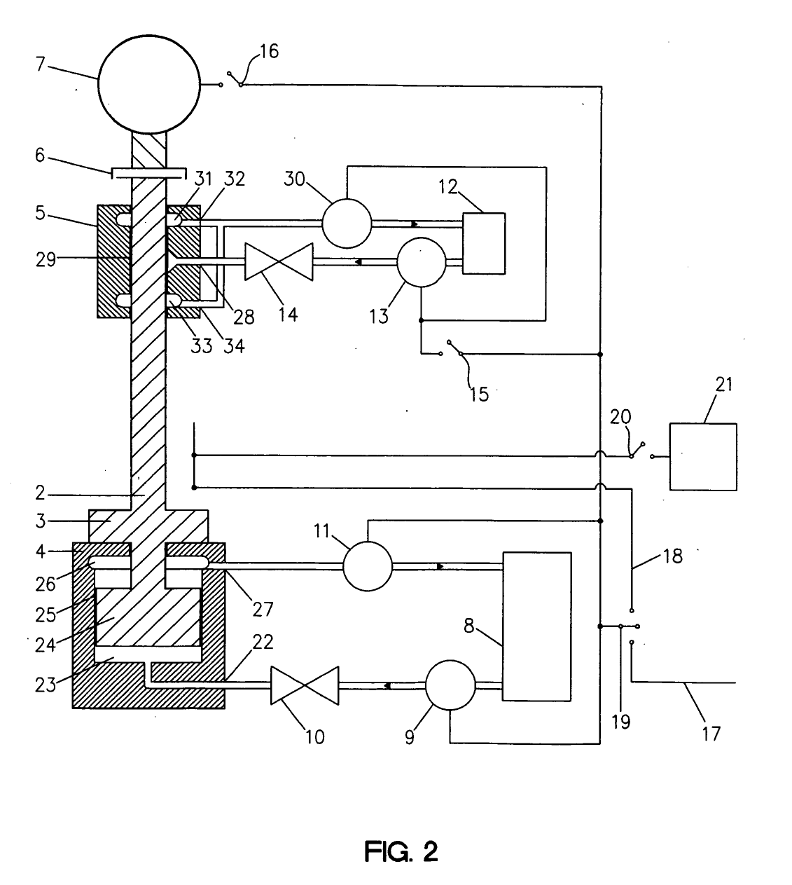

FIG. 2 is similar to FIG. 1, but with sectional views of components of the preferred embodiment of the invention as shown in an inoperative mode.

The vertical armature shaft 2 comprises a shaft collar 3 a preferred distance above the shaft piston end 24. The purpose of the shaft collar 3 when seated on the base support assembly 4 is to support the weight of the armature. The shaft piston end 24 is housed in the cylindrical fluid chamber 23 of the base support assembly 4. Pressurized fluid entering the chamber 23 raises and suspends the armature shaft 2 a preferred distance to separate the shaft collar 3 above the base support assembly.

An armature shaft support assembly 5 comprises a sleeve fitting 29 on a preferred area of the armature shaft 2 with a pressurized lubricating system that comprises a power switch 15, a fluid reservoir 12, a fluid pump 13 to pressurize fluid through a one-way fluid pressure valve 14 on the line to the entrance port 28 of the support assembly 5 to the sleeve fitting 29 of the shaft 2. Two fluid collecting chambers 31 and 33 return fluid through their exit ports 32 and 34 to a fluid pump 30 to the fluid reservoir 12.

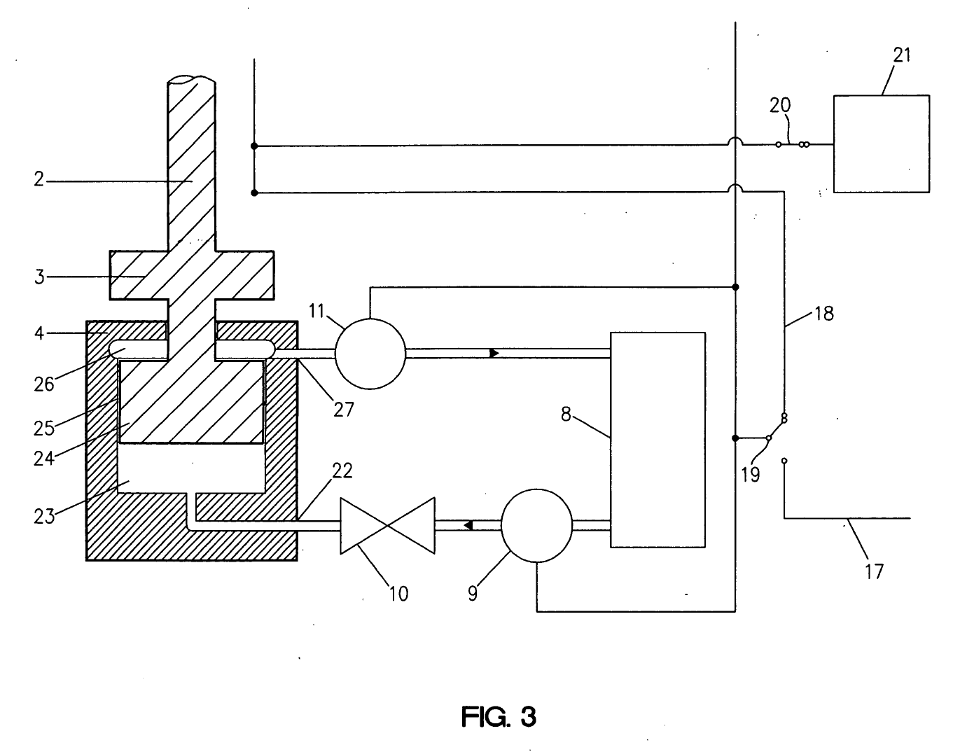

FIG. 3 is a partial view showing sectional views of the operative mode positions of the armature shaft collar 3, the shaft piston end 24, and the base support assembly 4; and also showing the base support assembly hydraulic system and other system switches.

The generator system power switch 19 is switched to the outside power source 17 activating fluid pumps 9 and 11 in the base assembly hydraulic system. Fluid from the reservoir 8 is pressurized by fluid pump 9 through the one-way fluid pressure retaining valve 10 to the entrance port 22 of the base support assembly fluid chamber 23. The pressurized fluid in the base support fluid chamber 23 raises and suspends the armature and provides lubrication by being allowed to flow up between the base fluid chamber wall and the shaft piston wall 25 into the fluid collection chamber 26 above the shaft piston 24. Fluid from the fluid collection chamber 26 exits through exit port 27 to fluid pump 11 and then into the fluid reservoir 8.

Referring to the flow chart and to FIG. 2; when the armature shaft 2 has been raised and the shaft collar 3 is suspended above the base support assembly 4 the shaft support assembly pump switch 15 is closed providing lubrication to sleeve fitting 29 of the shaft support assembly 5 and the armature shaft 2. The motor switch 16 is then closed engaging the motor 7 with the armature shaft 2 through the clutch 6 to provide rotational drive to the armature shaft 2. When the generator is fully operating, the generator system power source switch 19 can be switched to the generated power source 18. The load switch is then closed to provide generated electrical power to the load 21.

Referring to turn down power, the load switch 20 is switched to open. The generator system power source switch 19 is switched to outside power source 17. The motor switch 16 is switched to open. When the armature has stopped rotational movement, the shaft support lubricating pump switch 15 is switched to open. The generator system power switch 19 is switched to open causing fluid pumps 9 and 11 of the base support assembly hydraulic system to be inoperative. The one-way fluid pressure retaining valve 10 maintains fluid pressure in the base support assembly fluid chamber 23 as the weight of the armature forces fluid to flow up between the wall of the fluid chamber and the shaft piston wall 25 into the fluid collecting chamber 26 until the armature shaft collar 3 is seated on the base support assembly 4.

The turn up and the turn down sequences can be performed manually or with appropriate sensor switches can be performed automatically.

Many modifications and other embodiments of the invention will come to the mind of one skilled in the art having the benefit of the teachings presented in the foregoing descriptions and the associated drawings. Therefore, it is understood that the invention is not to be limited to the specific embodiment disclosed, and that modifications and embodiments are intended to be included within the scope of the appended claims.

| TURN UP | TURN DOWN |
|---|---|
| Switch 19 to outside power | Open switch 20 from load 21. |
| source 17. | Switch 19 to outside power source 17. |
| Base support assembly hydraulic | Switch 16 is opened; motor deactivated. |
| system activated. | When armature stops rotating |
| Fluid pressure in 23 raises | switch 15 is opened; shaft support |
| and suspends the armature. | lubricating pumps 13 and 30 are off. |
| Close switch 15; shaft support | Switch 19 to open; base assembly |
| assembly lubricating pumps 13 | hydraulic system pumps 9 and 11 |
| and 30 activated. | are off. |
| Close switch 16 to activate | The armature then lowers and the |
| motor. | shaft collar seats on the base support |
| When generator fully operating | assembly. |
| switch 19 to 18 generated | |
| power. | |
| Close switch 20 generated power | |
| to 21 load. | |

What is claimed is:

1. An electric power generator in a vertical design supplying electric power as a direct current electrical generator or an alternating current electric generator, which comprises:
a vertical generator having a vertical rotating hydraulically suspended armature supplying electrical power to a load with a means to connect and disconnect said generated power to the load;
a preferred means to rotationally drive the said armature with a means to activate and deactivate said means;
a means to replace the initial out side power source required to rotate the vertical armature with a portion of the generated power;
a vertical armature shaft having a shaft collar to support the weight of the armature, and a shaft piston end allowing pressurized fluid to raise and suspend the armature;
a base support assembly to support the weight of the armature at the said shaft collar, and having a cylindrical fluid chamber housing the said shaft piston, and having fluid enhance and exit ports with a hydraulic system to raise and suspend the armature;
a sleeve fitting armature shaft support and lubricating assembly with fluid entrance and exit ports with a pressurized fluid system to lubricate the said sleeve fitting.

2. The base support assembly hydraulic system as claimed in claim 1 also comprises:
a fluid reservoir;
a fluid pump to pressurize fluid from the said reservoir through a one-way fluid pressure retaining valve on the line to the entrance port to the said base support assembly cylindrical fluid chamber to raise and then suspend the armature during rotational movement;
a channel allowing pressurized fluid from the said base assembly fluid chamber to flow up and lubricate between the chamber wall and the shaft piston wall and then flow into the fluid collection chamber above the shaft piston;
a fluid collection chamber exit port to a fluid return pump connected to the said fluid reservoir;
a means to power and interrupt power to the fluid pumps of the hydraulic system of base support assembly.

3. An armature shaft support and lubricating assembly as claimed in claim 1, which comprises:
a fluid reservoir;
a fluid pump connected to said fluid reservoir to pressurize fluid through a one-way fluid valve to an entrance port on the shaft support assembly to lubricate the sleeve fitting and then to flow to fluid collection chambers and exit through collecting chamber exit ports to lines connecting to a return fluid pump connected to said fluid reservoir;
a means to activate and deactivate the fluid pumps of the armature shaft support and lubricating assembly pressurized fluid system.
